(19) United States
(12) Patent Application Publication
(10) Pub. No.: US 2003/0074835 A1
(43) Pub. Date: Apr. 24, 2003

(54) Packaging for long-stemmed flowers having little or no leaf, in particular gerberas, anthuriums and arum lilies

(75) Inventors: Janus Adriaan Willem De Pagter, Dinteloord (NL); Nicoline De Haan, Breda (NL); Mieke Geertruida Margaretha Eeuwes, Rotterdam (NL)

Correspondence Address: HANDAL & MOROFSKY, 80 WASHINGTON STREET, NORWALK, CT, 06854, US

(73) Assignee: Pagter & Partners International B.V., Dinteloord (NL)

(21) Appl. No.: 10/277,018

(22) Filed: Oct. 21, 2002

(30) Foreign Application Priority Data
Oct. 24, 2001 (NL) 1019223

(51) Int. Cl. A01G 5/00; A47G 7/00

(52) U.S. Cl. 47/41.01

(57) ABSTRACT

Packaging for long-stemmed flowers having little or no leaf comprises one or more holders for accommodating water, one or more display elements supported above said holder for displaying the flowers, which display elements have an upright wall with openings for allowing the stems of the flowers to pass through, and means for positioning the display elements such that the flower stems that extend through the said openings extend into the holders. One or more side walls are joined to the wall provided with openings, which side walls are at an angle to the wall provided with openings and bear on an essentially horizontal support component that bears on or forms part of a holder or bears on or forms part of a part fitted around the holder and increasing the stability, such as a container or an extender rack placed on top of a container. The support component can also consist of flanges which, in the uppermost part of a container or extender rack placed thereon, extend inwards from the wall thereof.

The invention relates to a packaging for long-stemmed flowers having little or no leaf, in particular gerberas, anthuriums and arum lilies, comprising:

at least one holder for accommodating water,

one or more display elements supported above said holder for displaying the flowers, which display elements have an upright wall with openings for allowing the stems of the flowers to pass through,

and means for positioning the display elements such that the flower stems that extend through the said openings extend into the said holder.

Packaging of this type is disclosed in International Patent Application WO 00/73171 in the name of Pagter & Partners International B.V.

In this known embodiment each display element consists of a rectangular tube that is provided at the corners with flanges projecting obliquely outwards that, for positioning said tube, are pushed into cuts which have been made in projections that are oriented upwards and form part of a platform bearing on a container. In another embodiment said flanges have stepped cut-outs at the bottom and the stepped parts of said flanges bear on the stepped outside edge of a vase. These embodiments have the disadvantage that fitting the display elements takes some time and care.

The aim of the invention is to avoid this disadvantage and to this end the packaging mentioned in the preamble is characterised in that one or more side walls are joined to the wall provided with openings, which side walls are at an angle to the wall provided with openings and bear on an essentially horizontal support component that bears on or forms part of said holder or bears on or forms part of a part fitted around the holder and increasing the stability, such as a container or an extender rack placed on top of a container.

It is pointed out that rectangular gerbera boxes having a base provided with openings and four upright side walls are known and are available commercially. The stems protrude through the openings and the flowers are on or just above the top surface of the base. In the known use of these packagings the boxes are positioned horizontally on top of one another and the stems do not extend into water. Preferably, use is made of such commercially available boxes for the display elements, the display elements consisting of or being derived from these boxes, the base of which forms the upright wall provided with openings and one or more side walls of which bear on a said essentially horizontal support component.

With the packaging according to the invention the boxes can easily be placed vertically.

Said horizontal support component can consist of a separate platform that bears on a container or an extender rack placed on top of a container, which platform is provided with at least one opening for allowing the flower stems to pass through.

The support component can also consist of flanges which, in the uppermost part of a container or extender rack placed thereon, extend inwards from the wall thereof.

If the boxes are placed on a platform resting on a container or extender rack, it is preferable that the platform is provided with upright parts to restrain two boxes located opposite one another some distance apart, the platform is provided with parts oriented downwards to position the platform with respect to the top edge of the container or extender rack and means are added in order essentially to maintain the distance between the two boxes.

The means to enable two boxes located opposite one another to be held some distance apart can consist, for example, of cardboard or plastic strips that are stapled to the uppermost side walls of the two boxes or the vertical side walls of the two boxes. It would also be possible to make use of rigid strips with clamping projections oriented downwards which are clicked over vertical side walls of two boxes to clamp them. These rigid strips can be fastened with respect to the platform by means of, for example, an elastic band. The invention is not restricted to the design of the spacers.

Preferably the said holder consists of a flexible bag that is fixed by its top edge.

The invention will now be explained in more detail with reference to the figures.

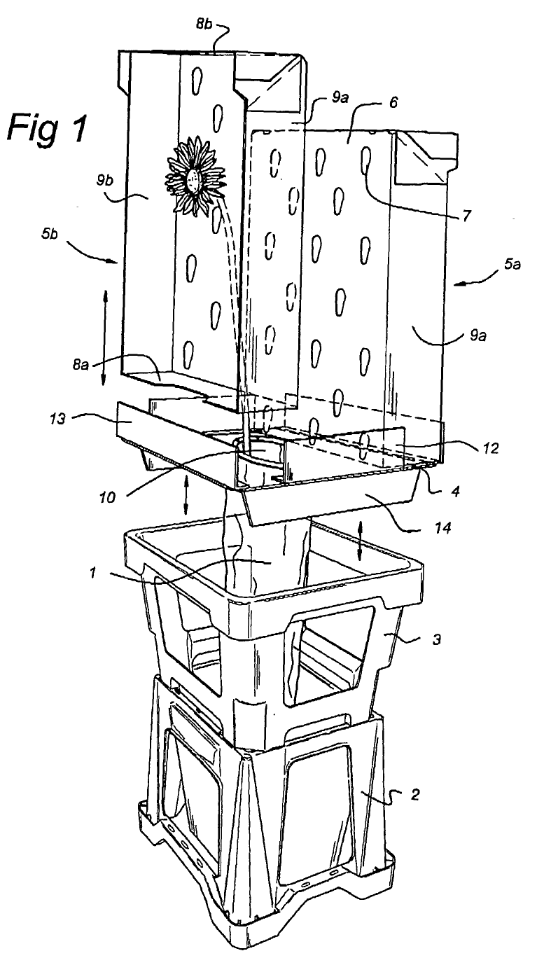

FIG. 1 shows a perspective view of gerbera packaging according to the invention in the disassembled state.

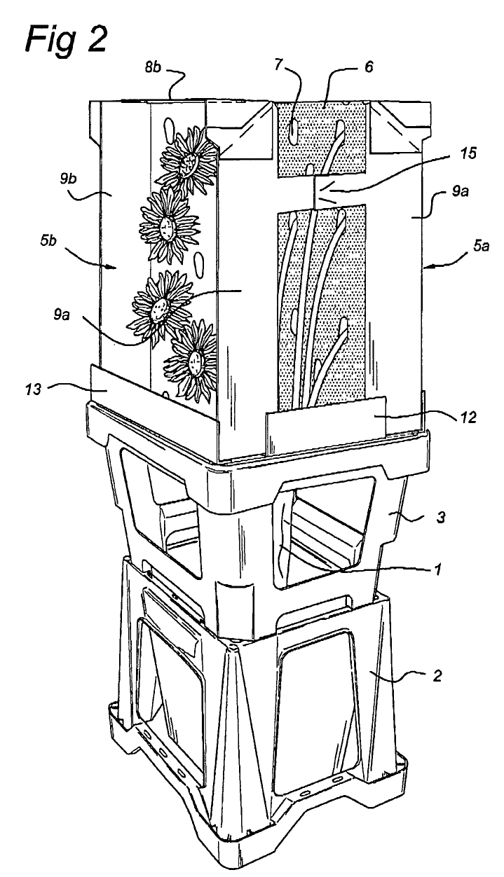

FIG. 2 shows a perspective view of gerbera packaging according to the invention in the state ready for use.

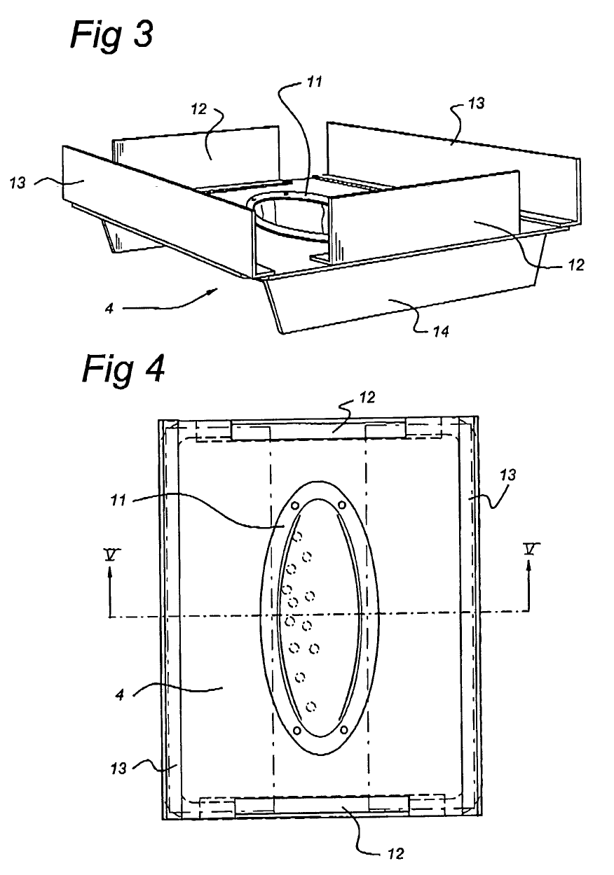

FIG. 3 shows a perspective view of a platform used in the packaging according to FIGS. 1 and 2.

FIG. 4 shows a plan view of the packaging according to FIGS. 1 to 3 without gerbera boxes.

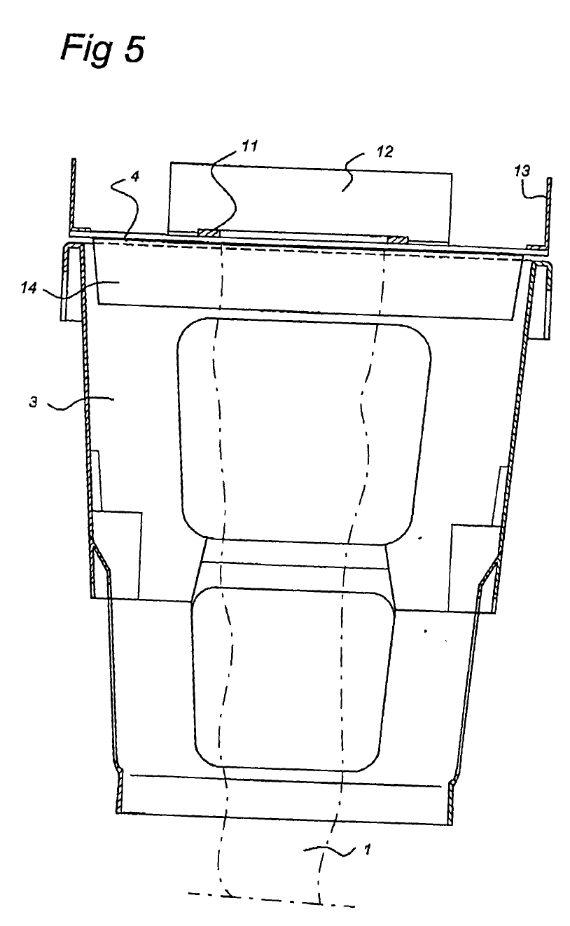

FIG. 5 shows a section along the line V-V in FIG. 4, the bottom part of the packaging (container) being omitted.

The packaging shown in FIGS. 1 and 2 for gerberas or other flowers with long stems and little or no leaf comprises a holder 1 in the form of a flexible bag for accommodating water, a container 2 placed on the ground, an extender rack 3 placed on top of this container 2, a platform 4 bearing on the top edge of the extender rack 3 and two gerbera boxes 5a, 5b, which serve as display elements.

Openings 7 have been made in the base 6 of the boxes 5a, 5b, through which openings the flower stems are inserted from the inside of the boxes into the water that is contained in the holder 1. The boxes 5a, 5b are known commercially available boxes which, apart from said base 6, have two short side walls 8a, 8b opposite one another and two long side walls 9a, 9b opposite one another. Incidentally, it would also be possible for one or more of the three side walls 8b, 9a, 9b of the boxes 5a, 5b not to be present. Thus, a display element can bear solely on the bottom edges of the long side walls 9a, 9b, one or both short side walls 8a, 8b being removed, or a display element can bear solely on the short side wall 8a, one or more of the other side walls 8b; 9a, 9b being removed.

An opening 10 has been made in the platform 4 and directly below this opening the top edge of the holder 1 is fixed to the platform 4, for example by means of a ring over which the top edge of the holder 1 has been wrapped and which has been fastened to the platform, or the platform has—bordering the opening therein—two L-shaped lips opposite one another, over which lips the top edge of the holder 1 has been wrapped and fastened by means of an elastic band. Various ways of fixing a flexible holder are shown and described in said International Patent Application WO 00/73171.

The platform 4 has an upright flange 12 and 13, respectively, along each of the short and long sides and these flanges ensure that the boxes 5a, 5b, i.e. the display elements derived therefrom, placed on the platform 4 are not able to move beyond the maximum periphery of the extender rack 3. In order to maintain a gap between the boxes 5a, 5b, strips 15 are fixed to the side walls 9a, 9b or to the top walls 8b of the boxes, for example by staples. The platform 4 is provided with a flange 14, oriented downwards, on the two short sides. These flanges extend into the extender rack and thus position the platform 4.

Various variants are possible within the context of the invention. Instead of the combination of a relatively small container 2 and an extender rack 3 it is possible to use a large container. Instead of one or more flexible holders 1 it is possible to use one or more holders made of rigid material. In the latter case the separate platform 4 could be replaced by a support component for the boxes 5a, 5b that is formed by flanges which extend in the uppermost part of the extender rack 3 (or in the case of a large container in the uppermost part of that container) from the wall thereof towards the inside and leave a gap free to allow the holder 1 to pass through. In the case of a rigid holder or rigid holders it is even possible to let the support component for supporting the boxes 5a, 5b form part of the rigid holders.

The invention is not restricted to the use of commercially available gerbera packaging boxes from which one or more side walls have optionally been removed, but this embodiment is preferred.

1. Packaging for long-stemmed flowers having little or no leaf, in particular gerberas, anthuriums and arum lilies, comprising:
at least one holder (1) for accommodating water,
one or more display elements (5a, 5b) supported above said holder for displaying the flowers, which display elements have an upright wall (6) with openings (7) for allowing the stems of the flowers to pass through,
and means (4) for positioning the display elements (5a, 5b) such that the flower stems that extend through the said openings extend into the said holder,
characterised in that one or more side walls are joined to the wall (6) provided with openings, which side walls (8a; 9a, 9b) are at an angle to the wall (6) provided with openings and bear on an essentially horizontal support component (4) that bears on or forms part of said holder or bears on or forms part of a part fitted around the holder and increasing the stability, such as a container or an extender rack (3) placed on top of a container (2).

2. Packaging according to claim 1, characterised in that the display elements (5a, 5b) consist of or are derived from open boxes, the base of which forms the upright wall (6) provided with openings and one or more side walls (8a; 9a, 9b) of which bear on a said essentially horizontal support component (4).

3. Packaging according to claim 1 or 2, characterised in that said support component consists of a separate platform (4) that bears on a container or an extender rack (3) placed on top of a container (2), which platform is provided with at least one opening (10) for allowing the flower stems to pass through.

4. Packaging according to claim 1 or 2, characterised in that said support component consists of flanges which, in the uppermost part of a container or extender rack placed thereon, extend inwards from the wall thereof.

5. Packaging according to claim 3, characterised in that the platform (4) is provided with upright parts (12, 13) to restrain two boxes located opposite one another some distance apart, in that the platform is provided with parts (14) oriented downwards to position the platform with respect to the top edge of the container or extender rack and in that means (15) are added in order essentially to maintain the distance between the two boxes.

6. Packaging according to one of the preceding claims, characterised in that said holder (1) consists of a flexible bag that is fixed by its top edge to a platform.
